(19) United States
(12) Patent Application Publication
(10) Pub. No.: US 2013/0239743 A1
(43) Pub. Date: Sep. 19, 2013

(54) Flywheel

(71) Applicants: Heng-Yuan Liu, Yangmei City (TW); Yi-Rong Peng, Yangmei City (TW)

(72) Inventors: Heng-Yuan Liu, Yangmei City (TW); Yi-Rong Peng, Yangmei City (TW)

(21) Appl. No.: 13/418,426

(22) Filed: Mar. 13, 2012

(51) Int. Cl. F16F 15/31

(52) U.S. Cl. 74/572.11

(57) ABSTRACT

A flywheel includes a disc mounted around a central shaft. An energy-storing section and an energy-releasing section are defined in two sides of the second side. A plurality of rods is slideably mounted on the disc. The rods are arranged in a radiant manner and spaced from one another in a circumferential direction about the central shaft. Each rod has an inner end spaced from the central shaft and an outer end having a spacing to the central shaft larger than the inner end. Each rod slides toward the central shaft under action of gravitational force while the rod is moving through an upper portion of the energy-storing section. Each rod slides away from the central shaft under action of the gravitational force while the rod is moving through a lower portion of the energy-releasing section. A plurality of weights is respectively mounted to the outer ends of the rods.

### BACKGROUND OF THE INVENTION

The present invention relates to a flywheel and, more particularly, to a flywheel including a plurality of rods that can continuously change the momentum of inertia to increase the energy stored by the flywheel.

A flywheel with a fixed inertia is generally provided in a mechanical power transmission system to store kinetic energy. Such an approach is traditional and used in blank forming machines of ceramics, spinning wheels, and steam engines during the Industrial Revolution. In modern days, flywheels are used in machine tools, engines, generators, etc. These flywheels are used to provide a uniform speed. The energy stored in the flywheel is not much, and the storage time of is short.

The energy stored by a flywheel is in proportion to the mass of the flywheel and in portion to the square of the speed of the flywheel. Thus, the energy stored in the flywheel can be increased if the speed of the flywheel is increased. However, the stress imparted to the flywheel is also increased when the speed is increased. As a result, the speed of the flywheel is limited by the maximum stress bearable by the material of the flywheel. Thus, it is an issue to increase the energy-storing capacity of the flywheel at a fixed speed and a fixed mass.

### BRIEF SUMMARY OF THE INVENTION

The primary objective of the present invention is to provide a flywheel including a plurality of rods that can continuously change the momentum of inertia to increase the energy stored by the flywheel.

A flywheel according to the present invention includes a body having a central shaft. A disc is mounted around the central shaft and rotatable about a rotating axis. The disc includes a first side and a second side opposite to the first side, with an energy-storing section defined in the first side, and with an energy-releasing section defined in the second side. Each of the energy-storing section and the energy-releasing section includes a lower portion below the rotating axis and an upper portion above the rotating axis. A plurality of rods is slideably mounted on the disc. The rods are arranged in a radiant manner and spaced from one another in a circumferential direction about the central shaft. Each of the plurality of rods has an inner end spaced from the central shaft and an outer end having a spacing to the central shaft larger than the inner end. Each of the plurality of rods slides toward the central shaft under action of gravitational force while the rod is moving through the upper portion of the energy-storing section. Each of the plurality of rods slides away from the central shaft under action of the gravitational force while the rod is moving through the lower portion of the energy-releasing section. A plurality of weights is respectively mounted to the outer ends of plurality of the plurality of rods.

Preferably, the disc includes a plurality of hollow cylinders arranged in a radiant manner. The inner end of each of the plurality of rods is slideably received in one of the plurality of hollow cylinders. The outer end of each of the plurality of rods is located outside of the plurality of hollow cylinders.

Preferably, each of the plurality of rods has a longitudinal axis not intersecting with the rotating axis.

Preferably, a guiding track is mounted in the energy-storing section of the disc. The guiding track includes a lower end below the rotating axis and a critical contact point located between the upper and lower portions of the energy-storing section. The guiding track includes increasing spacings to an outer periphery of the disc from the lower end of the guiding track toward the critical contact point of the guiding track. Each of the plurality of weights contacts with and is compressed by the guiding track while moving from the lower end to the critical contact point. Each of the plurality of rods slides toward the central shaft under action of the gravitational force after the rod has moved upward and passed through the critical contact point.

Preferably, a ball is rotatably mounted to each of the plurality of weights. The ball of each of the plurality of weights rolls on the guiding track when the weight is moving from the lower end to the critical contact point of the guiding track.

The present invention will become clearer in light of the following detailed description of illustrative embodiments of this invention described in connection with the drawings.

### DESCRIPTION OF THE DRAWINGS

FIG. 1 shows a diagrammatic side view of a flywheel according to the present invention.

FIG. 2 shows a partial, cross sectional view of the flywheel of FIG. 1.

FIG. 3 shows a partial, cross sectional view of the flywheel of FIG. 1, illustrating outward movement of rods of the flywheel.

FIG. 4 shows a partial, cross sectional view of the flywheel of FIG. 1, illustrating inward movement of the rods of the flywheel.

### DETAILED DESCRIPTION OF THE INVENTION

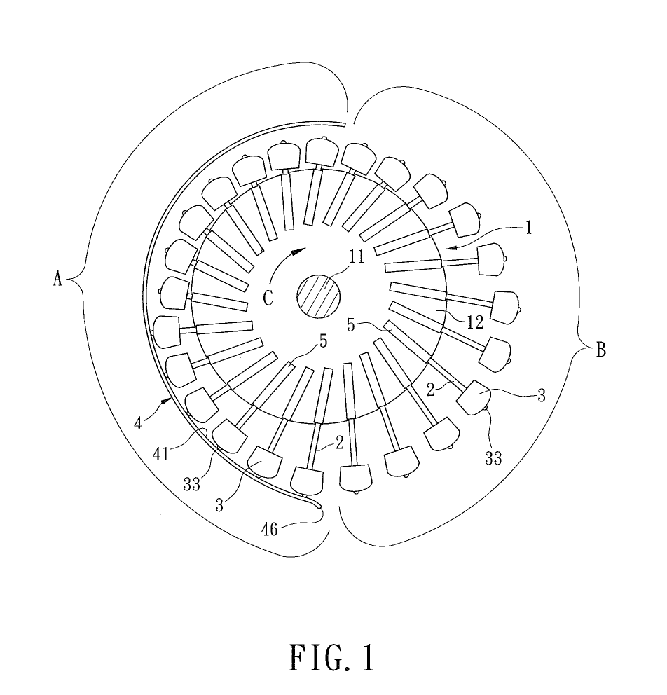

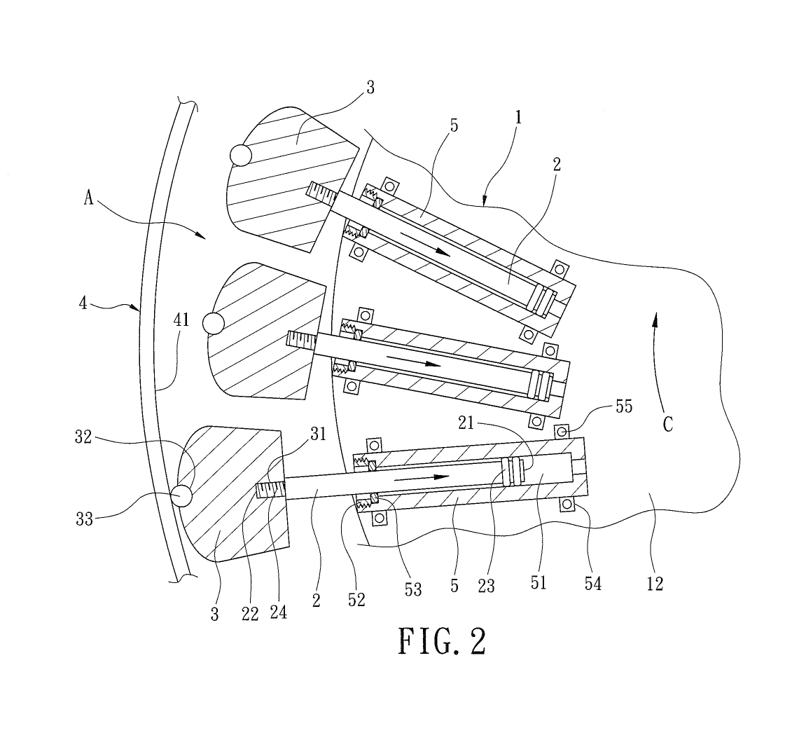

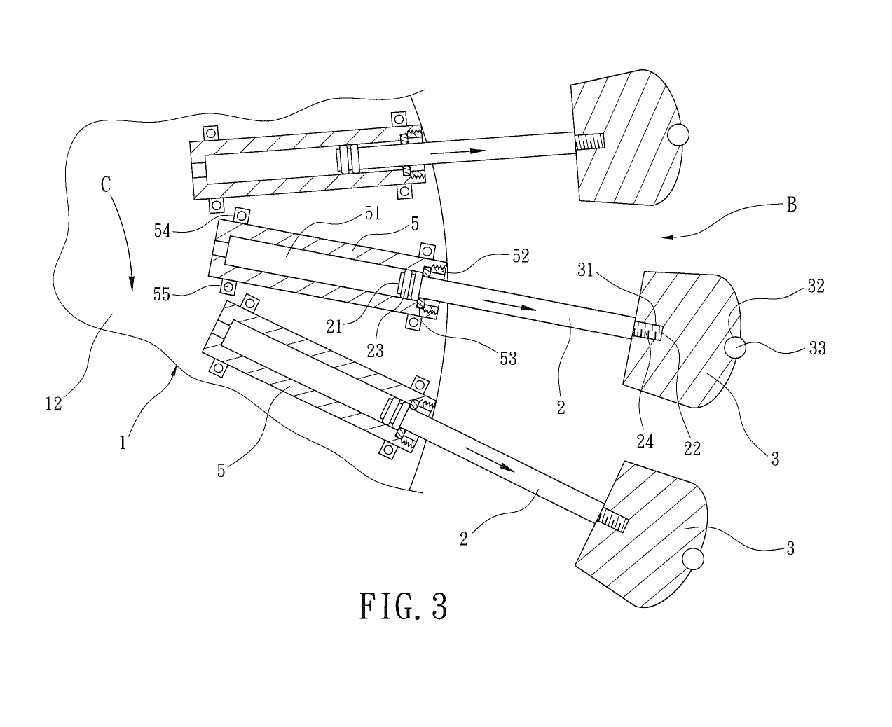

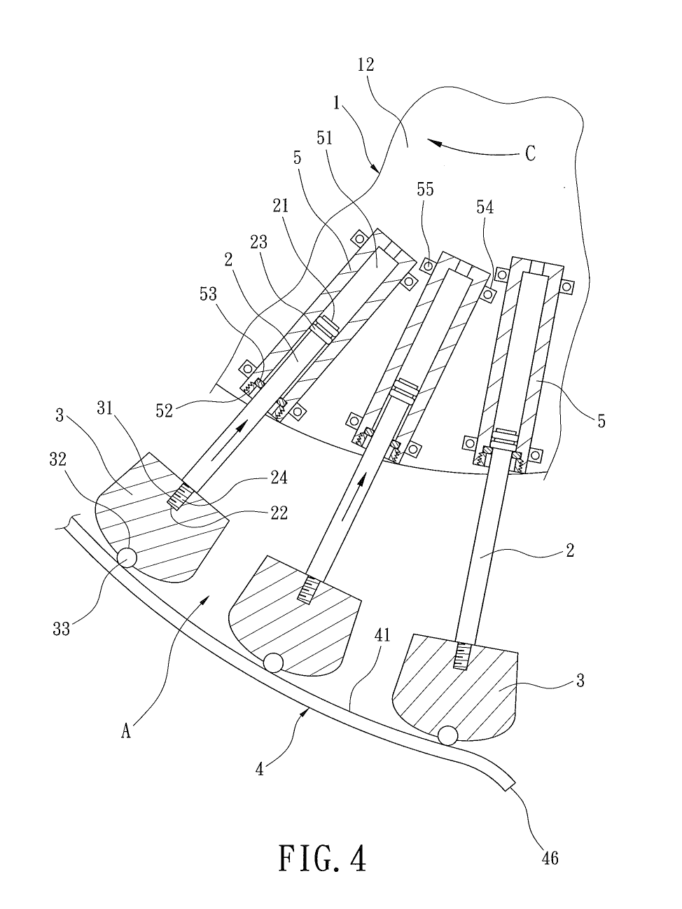

FIGS. 1-4 show an example of a flywheel according to the present invention. In the form shown, the flywheel includes a body 1, a plurality of rods 2, a plurality of weights 3, a guiding track 4, and a plurality of hollow cylinders 5.

The body 1 includes a central shaft 11. A disc 12 is mounted around the central shaft 11 and rotatable about a rotating axis together with the central shaft 11. The disc 12 includes a first side and a second side opposite to the first side. An energy-storing section A defined in the first side, and an energy-releasing section B is defined in the second side. Each of the energy-storing section A and the energy-releasing section B includes a lower portion below the rotating axis and an upper portion above the rotating axis.

Each rod 2 is slideably mounted on the disc 12. The rods 2 are arranged in a radiant manner and spaced from one another in a circumferential direction about the central shaft 11. Each rod 2 has an inner end 21 spaced from the central shaft 11 and an outer end 22 having a spacing to the central shaft 11 larger than the inner end 21. In the form shown, the outer end 22 of each rod 2 includes a stud 24. Each rod 2 has a longitudinal axis not intersecting with the rotating axis.

In the form shown, each weight 3 includes a connecting portion 31 in the form of a screw hole threadedly engaged with the stud 24 of the outer end 22 of one of the rods 2. Furthermore, a ball 33 is rotatably received in a recessed portion 32 of each weight 3 opposite to the connecting portion 31.

The guiding track 4 is located in the energy-storing section A of the disc 12. The guiding track 4 includes a lower end 46 below the rotating axis and a critical contact point between the upper and lower portions of the energy-storing section A. The guiding track 4 includes increasing spacings to an outer periphery of the disc 2 from the lower end 46 toward the critical contact point. The guiding track 4 further includes a surface 41 facing the disc 2 to guide and support the weights 3 and the balls 33.

The hollow cylinders 5 are mounted on a side of the disc 2 and arranged in a radiant manner. Bolts or the like are extended through fixing portions 54 of each hollow cylinder 5 into the disc 2. The inner end 21 of each rod 2 is slideably received in one of the hollow cylinders 5. The hollow cylinders 5 and the rods 2 are provided with guiding rings 23 and 53 to reduce friction. Each hollow cylinder 5 further includes an end cap 52 to retain the guiding ring 53. The outer end 22 of each rod 2 and the corresponding weight 3 are located outside of the corresponding hollow cylinder 5, allowing easy assembly and detachment.

When the disc 12 rotates about the rotating axis in a direction indicated by arrow C, the rods 2 slide toward or away from the disc 12 according to the angular positions of the rods 2. Specifically, when a rod 2 is moving from the lower end 46 to the critical contact point of the guiding track 4, the corresponding weight 3 contacts with and is compressed by the surface 41 of the guiding track 4. Thus, the rod 2 is moved into the hollow cylinder 5 except the outer end 22. The moment of inertia of the rod 2 and the weight 3 is decreased. The ball 33 provides smooth sliding movement for the weight 3.

When a rod 2 is moving through the upper portion of the energy-storing section B above the critical contact point of the guiding track 4, the rod 2 slides toward the central shaft 11 under action of gravitational force.

When a rod 2 is moving through the lower portion of the energy-releasing section B, with the rod 2 slides away from the central shaft 11 under action of the gravitational force as well as centrifugal force acting on the rod 2 and the corresponding weight 3. Thus, the rod 2 extends out of the corresponding cylinder 5 and partially outside of the disc 2. The moment of inertia of the rod 2 and the weight 3 is increased, leading to an increase in the energy of the flywheel while cooperating with the centrifugal force. The momentum of inertia of each weight 3 is decreased again when the weight 3 is moving through the energy-storing section A. Thus, by continuously changing the momentum of inertia of each weight 3, the energy stored by the flywheel can be increased. The power of the flywheel can be transmitted through the central shaft 11 or other conventional transmission devices. The flywheel is suitable for driving a generator to produce electricity.

Although specific embodiments have been illustrated and described, numerous modifications and variations are still possible without departing from the essence of the invention. The scope of the invention is limited by the accompanying claims.

1. A flywheel comprising:
a body including a central shaft, with a disc mounted around the central shaft and rotatable about a rotating axis, with the disc including a first side and a second side opposite to the first side, with an energy-storing section defined in the first side, with an energy-releasing section defined in the second side, with each of the energy-storing section and the energy-releasing section including a lower portion below the rotating axis and an upper portion above the rotating axis;
a plurality of rods slideably mounted on the disc, with the plurality of rods arranged in a radiant manner and spaced from one another in a circumferential direction about the central shaft, with each of the plurality of rods having an inner end spaced from the central shaft and an outer end having a spacing to the central shaft larger than the inner end, with each of the plurality of rods sliding toward the central shaft under action of gravitational force while the rod is moving through the upper portion of the energy-storing section, with each of the plurality of rods sliding away from the central shaft under action of the gravitational force while the rod is moving through the lower portion of the energy-releasing section; and
a plurality of weights respectively mounted to the outer ends of plurality of the plurality of rods.

2. The flywheel as claimed in claim 1, with the disc including a plurality of hollow cylinders arranged in a radiant manner, with the inner end of each of the plurality of rods slideably received in one of the plurality of hollow cylinders, with the outer end of each of the plurality of rods located outside of the plurality of hollow cylinders.

3. The flywheel as claimed in claim 1, with the each of the plurality of rods having a longitudinal axis not intersecting with the rotating axis.

4. The flywheel as claimed in claim 1, further comprising: a guiding track in the energy-storing section of the disc, with the guiding track including a lower end below the rotating axis and a critical contact point located between the upper and lower portions of the energy-storing section, with the guiding track including increasing spacings to an outer periphery of the disc from the lower end of the guiding track toward the critical contact point of the guiding track, with each of the plurality of weights contacting with and compressed by the guiding track while moving from the lower end to the critical contact point, with each of the plurality of rods sliding toward the central shaft under action of the gravitational force after the rod has moved upward and passed through the critical contact point.

5. The flywheel as claimed in claim 4, with a ball rotatably mounted to each of the plurality of weights, with the ball of each of the plurality of weights rolling on the guiding track when the weight is moving from the lower end to the critical contact point of the guiding track.
